(19) United States
(12) Patent Application Publication
(10) Pub. No.: US 2026/0225863 A1
(43) Pub. Date: Aug. 6, 2026

(54) HOIST SYSTEM

(71) Applicant: Tom Thornton, Valley, NE (US)

(72) Inventor: Tom Thornton, Valley, NE (US)

(21) Appl. No.: 19/042,782

(22) Filed: Jan. 31, 2025

(51) Int. Cl. B66C 23/48; B66C 23/42; B66D 3/08; B66D 3/18

(52) U.S. Cl. CPC B66C 23/485; B66C 23/42; B66D 3/08; B66D 3/18; B66C 2700/08; B66D 2700/0141; B66D 2700/0191; B66D 2700/025; B66D 2700/026

(57) ABSTRACT

A hoist system may include, but is not limited to an extension member; a sleeve member configured to at least partially receive a portion of the extension member, the sleeve member including at least one slot portion; a first winch cable routing anchor operably coupled to the extension member, the first winch cable routing anchor projecting from the extension member through the at least one slot portion of the sleeve member; and a winch configured to retract or extend a winch cable; wherein the winch cable is routed at least from the winch to the first winch cable routing anchor.

### TECHNICAL FIELD

The present disclosure generally relates to the field of lift systems, and more particularly, to a motorized lift system having a series of pullies configured to route a lift line connected to a motor to raise and lower a lifting arm.

### BRIEF DESCRIPTION OF THE DRAWINGS

The numerous advantages of the disclosure may be better understood by those skilled in the art by reference to the accompanying figures in which:

FIG. 1 shows a hoist system in a retracted state;

FIG. 2 shows a hoist system in an at least partially extended state;

FIG. 3 shows a hoist system in an at least partially extended state; and

FIG. 4 shows an enlarged view of a hoist system lifting subsystem.

### DETAILED DESCRIPTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

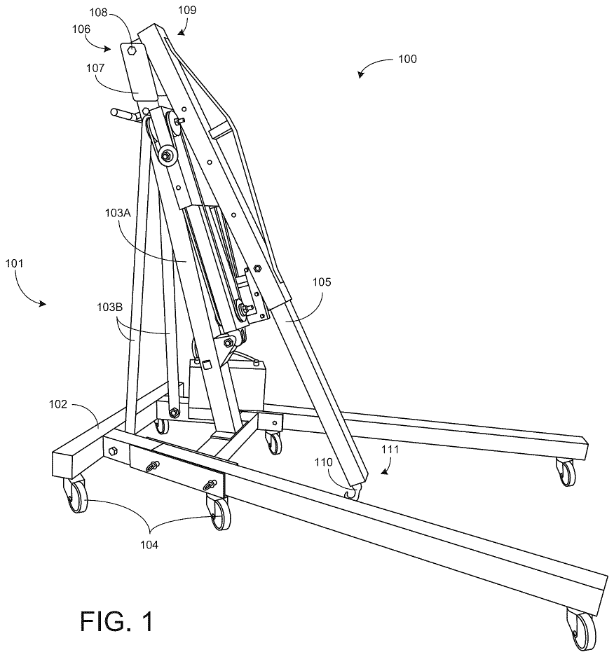

Reference will now be made in detail to the subject matter disclosed, which is illustrated in the accompanying drawings. Referring generally to FIGS. 1 through 4, embodiments of the present disclosure are generally directed to a hoist system 100.

Referring to FIG. 1, a hoist system 100 is shown. The hoist system 100 may include a frame 101 having one or more base members 102 supporting one or more upright members 103. In one example the one or more upright members 103 may include a primary support member 103A and one or more secondary truss members 103B. The frame 101 may be supported by one or more wheels 104 (e.g., caster-type wheels) to allow for transport of the hoist system 100 and any objects which may be supported by the hoist system 100.

The hoist system 100 may further include a lifting arm 105 rotatably coupled to a top end 106 of the primary support member 103A via a bracket 107 and through-bolt 108 at a first end 109 of the lifting arm 105. The lifting arm 105 may include at least one object support member 110 (e.g., a hook, a chain, a cable, a bracket, and the like) coupled to a second end 111 of the lifting arm 105. The object support member 110 may be configured to engage and lift an object (e.g. an engine from the engine bay of a vehicle, not shown) when the lifting arm 105 is raised.

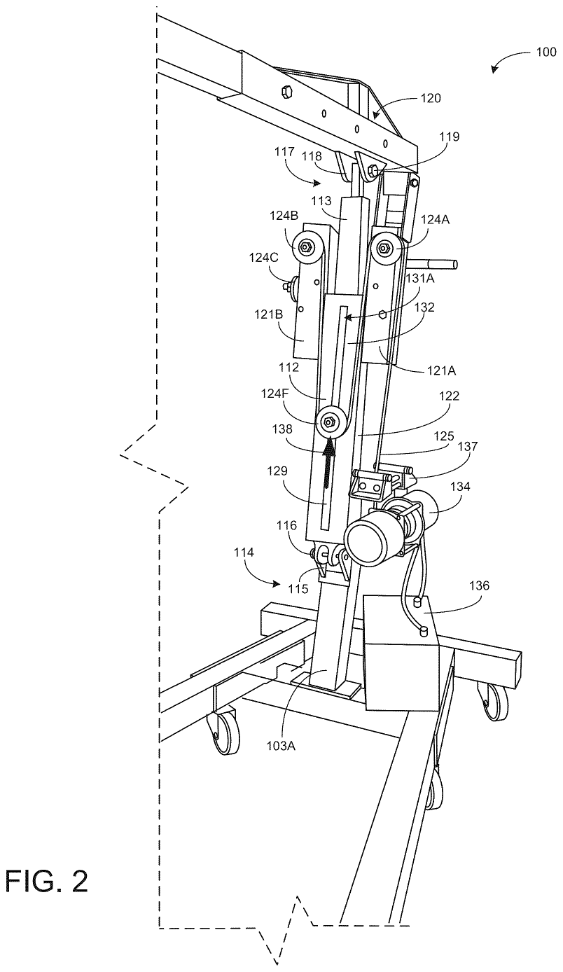

Referring to FIG. 2, the hoist system 100 may further include a sleeve member 112 and an extension member 113. The sleeve member 112 may be include a central tubular structure (e.g. a square steel tube) configured to at least partially receive the extension member 113. The sleeve member 112 may be rotatably coupled to a lower portion 114 of the primary support member 103A via a bracket 115 and through-bolt 116. A top end 117 of the extension member 113 may be rotatably coupled to the lifting arm 105 via a bracket 118 and through-bolt 119 at an intermediate position 120 of the lifting arm 105.

Referring to FIGS. 2-4, the sleeve member 112 may further include one or more winch cable support portions 121. For example, a first winch cable support portion 121A may extend from a first side 122 of the sleeve member 112 and a second winch cable support portion 121B may extend from a second side 123 of the sleeve member 112 opposite the first side 122.

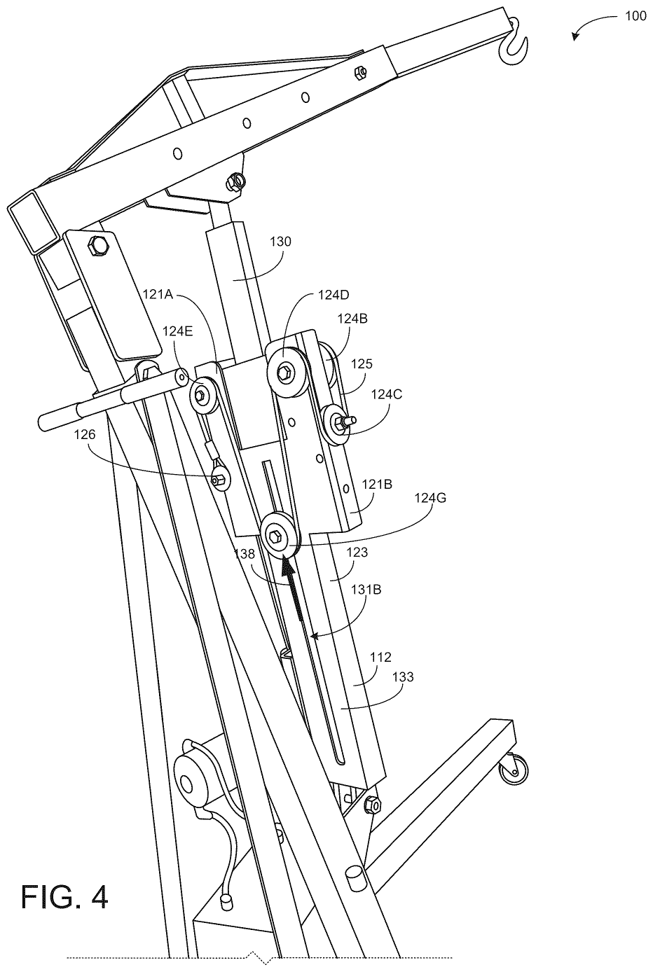

Referring to FIGS. 2 and 4, each of the winch cable support portions 121 may include one or more winch cable routing anchors 124 configured to provide routing support for a winch cable 125 which may be run between the winch cable routing anchors 124. In one example, the winch cable routing anchors 124 may be pulleys rotatably affixed to the winch cable support portions 121. In another example, the winch cable routing anchors 124 may be static bracket fixtures having a groove or guide surface or a sleeve structure configured to at least partially retain and direct the winch cable 125 as it is extended or retracted.

In one example, the first winch cable support portion 121A may include a winch cable routing anchor 124A, and a winch cable routing anchor 124E. Similarly, the second winch cable support portion 121B may include a winch cable routing anchor 124B, a winch cable routing anchor 124C, and a winch cable routing anchor 124D.

The sleeve member 112 may further include a winch cable tie-off 126 where a distal end of the winch cable 125 may be statically coupled to the sleeve member 112. The winch cable tie-off 126 may be a bolt and washer structure 127 configured to retain an end 128 (e.g., a looped end) of the winch cable 125.

The extension member 113 may also include one or more cooperating winch cable routing anchors 124. For example, the extension member 113 may include a winch cable routing anchor 124F on a first side 129 of the extension member 113 and a winch cable routing anchor 124G on a second side 130 of the extension member 113.

The sleeve member 112 may further include a first slot portion 131A disposed through a third side 132 of the sleeve member 112 and a second slot portion 131B disposed through a fourth side 133 of the sleeve member 112 opposite the third side 132. The winch cable routing anchor 124F may be coupled to the extension member 113 through the first slot portion 131A such that a winch cable-engaging portion of the winch cable routing anchor 124F (e.g. a pulley as shown, or, alternatively, a cable tie-off similar to that of winch cable tie-off 126) is disposed outside of the first slot portion 131A of the sleeve member 112 with a stem portion of the winch cable routing anchor 124F projecting through the first slot portion 131A that is affixed to the extension member 113. Similarly, the winch cable routing anchor 124G may be coupled to the extension member 113 through the second slot portion 131B such that a winch cable-engaging portion of the winch cable routing anchor 124G (e.g. a pulley) is disposed outside of the second slot portion 131B of the sleeve member 112 with a stem portion of the winch cable routing anchor 124G projecting through the second slot portion 131B that is affixed to the extension member 113.

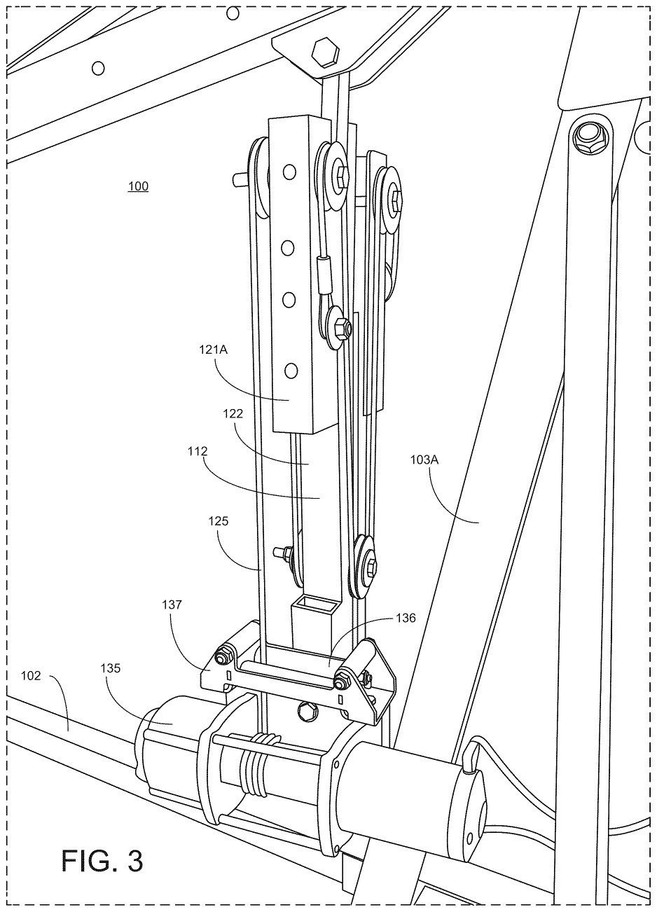

Referring to FIG. 3, the hoist system 100 may further include an electric-motor

winch 134 configured to extend and retract the winch cable 125. For example, the winch 134 may be a single line pull winch (e.g., a BADLAND® ZXR™ 5000 winch) having a 5000 pound lift capacity and wired or wireless remote control capabilities. The winch 134 may be mountable, via a winch mounting bracket 135 to the base of the sleeve member 112, to the primary support member 103A, or on the base members 102 in a position such that the winch cable 125 may be routed alongside substantially parallel to the sleeve member 112 and the extension member 113.

Referring to FIG. 2, the winch 134 may be powered by a battery 136 (e.g., a 12 VDC, Minimum 12 Ah battery) mountable to base of the sleeve member 112, the primary support member 103A, or on the base members 102.

Referring to FIGS. 2 and 3, the hoist system 100 may include a winch cable routing bracket 137 configured to ensure proper extension and retraction of the winch cable 125.

Referring to FIGS. 2 and 4, during basic operation, the winch cable 125 may be routed around at least the winch cable routing anchor 124A of the sleeve member 112, and the winch cable routing anchor 124F of the extension member 113. The end 128 of the winch cable 125 may then be coupled to a winch cable tie-off 126 of the sleeve member 112 (e.g., at a position corresponding to winch cable routing anchor 124B of FIG. 2). Further, the extension member 113 may be configured to freely slide within the sleeve member 112.

Referring to FIG. 1, the hoist system 100 is shown with the winch cable 125 in its fully extended position such that the first end 109 of the lifting arm 105 is at its lowest point.

Referring to FIGS. 2 and 4, upon retraction of the winch cable 125 by the winch 134 via the winch cable routing anchor 124A, the winch cable 125 may exert a force 138 on the winch cable routing anchor 124F so as to slide the extension member 113 upward within the sleeve member 112 until the first end 109 of the lifting arm 105 is at its highest point, as shown in FIG. 4.

As further shown in FIGS. 2 and 4, in another configuration, the winch cable 125 may be progressively routed around the winch cable routing anchor 124A of the sleeve member 112, the winch cable routing anchor 124F of the extension member 113, the winch cable routing anchor 124B of the sleeve member 112, the winch cable routing anchor 124C of the sleeve member 112, the winch cable routing anchor 124D of the sleeve member 112, the winch cable routing anchor 124G of the extension member 113, and the winch cable routing anchor 124E of the sleeve member 112. The end 128 of the winch cable 125 may then be coupled to the winch cable tie-off 126 of the sleeve member 112. In such a configuration, upon retraction of the winch cable 125, the winch cable 125 may exert the force 138 on both the winch cable routing anchor 124F on the first side 129 of the extension member 113 as well as on the winch cable routing anchor 124G on the second side 130 of the extension member 113. Such a dual application of force may serve to equilibrate the forces applied to the extension member 113 to avoid inducing a torque on the extension member 113 within the sleeve member 112.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

The previous description is presented to enable one of ordinary skill in the art to make and use the invention as provided in the context of a particular application and its requirements. As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

It is further contemplated that each of the embodiments of the method described above may include any other step(s) of any other method(s) described herein. In addition, each of the embodiments of the method described above may be performed by any of the systems described herein.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A hoist system comprising:
an extension member;
a sleeve member configured to at least partially receive a portion of the extension member, the sleeve member including a first slot portion;
a first winch cable routing anchor operably coupled to the extension member, the first winch cable routing anchor projecting from the extension member at least partially through the first slot portion of the sleeve member; and
a winch including a winch cable;
wherein the winch cable is routed at least from the winch to the first winch cable routing anchor.

2. The hoist system of claim 1, wherein the first winch cable routing anchor includes:
a winch cable tie-off.

3. The hoist system of claim 1, wherein the first winch cable routing anchor includes:
a pulley.

4. The hoist system of claim 3, further comprising:
a winch cable tie-off operably coupled to the sleeve member.

5. The hoist system of claim 4, further comprising:
a second winch cable routing anchor operably coupled to the sleeve member.

6. The hoist system of claim 5, wherein the winch cable is routed at least: from the winch to the first winch cable routing anchor, from the first winch cable routing anchor to the second winch cable routing anchor, and from the second winch cable routing anchor to the winch cable tie-off.

7. The hoist system of claim 5, further comprising:
a third winch cable routing anchor operably coupled to the extension member, the third winch cable routing anchor projecting from the extension member at least partially through a second slot portion of the sleeve member.

8. The hoist system of claim 7, wherein the winch cable is routed at least: from the winch to the first winch cable routing anchor, from the first winch cable routing anchor to the second winch cable routing anchor, and from the second winch cable routing anchor to third winch cable routing anchor; and from the third winch cable routing anchor to the winch cable tie-off.

9. The hoist system of claim 1, further comprising:
a second winch cable routing anchor operably coupled to the extension member.

10. The hoist system of claim 1, further comprising, a lifting arm operably coupled to the extension member.

11. The hoist system of claim 1, wherein the winch is a battery powered, motorized winch.

12. A hoist system comprising:
an extension member;
a sleeve member configured to at least partially receive a portion of the extension member, the sleeve member including a first slot portion and a second slot portion;
a first winch cable routing anchor operably coupled to the sleeve member;
a second winch cable routing anchor operably coupled to the extension member, the second winch cable routing anchor projecting from the extension member at least partially through the first slot portion of the sleeve member;
a third winch cable routing anchor operably coupled to the sleeve member;
a fourth winch cable routing anchor operably coupled to the sleeve member;
a fifth winch cable routing anchor operably coupled to the extension member, the fifth winch cable routing anchor projecting from the extension member at least partially through the second slot portion of the sleeve member;
a winch cable tie-off operably coupled to the sleeve member; and
a winch including a winch cable;
wherein the winch cable is routed at least from:
the winch to the first winch cable routing anchor,
from the first winch cable routing anchor to the second winch cable routing anchor,
from the second winch cable routing anchor to the third winch cable routing anchor,
from the third winch cable routing anchor to the fourth winch cable routing anchor,
from the fourth winch cable routing anchor to the fifth winch cable routing anchor, and
from the fifth winch cable routing anchor to the winch cable tie-off.
